(19) United States
(12) Patent Application Publication
(10) Pub. No.: US 2013/0124302 A1
(43) Pub. Date: May 16, 2013

(54) INDIVIDUAL-LEVEL MODELING

(71) Applicant: MARKETING EVOLUTION, INC., El Dorado Hills, CA (US)

(72) Inventor: Jason Rex Briggs, El Dorado Hills, CA (US)

(73) Assignee: MARKETING EVOLUTION, INC., El Dorado Hills, CA (US)

(21) Appl. No.: 13/666,686

(22) Filed: Nov. 1, 2012

Related U.S. Application Data
(60) Provisional application No. 61/554,437, filed on Nov. 1, 2011.

(51) Int. Cl. G06Q 30/02

(52) U.S. Cl. CPC G06Q 30/0245
USPC 705/14.44

(57) ABSTRACT

A method includes collecting individual-level data (for example, survey data) corresponding to each of one or more individuals who has been exposed to advertising for a product or service. A representative sample may be created from the individual-level data. A model may be created based on factors relating to acquisition of the product or service. A response to the advertisements is assessed based on the model. In some embodiments, intermediate measures to sales are included in the model. In some embodiments, the individual-level model is integrated with a historical model.

### PRIORITY CLAIM

This application claims priority to U.S. Provisional Application No. 61/554,437 entitled “ASSESSING ADVERTISING EFFECTIVENESS WITH INDIVIDUAL-LEVEL MODELING” to Briggs filed Nov. 1, 2011, which is incorporated herein by reference in its entirety.

### BACKGROUND

1. Field

The present disclosure relates generally to systems that can be used to assess advertising and marketing effectiveness and systems that provide graphical information from computer models.

2. Description of Related Art

Marketers face an increasingly challenging advertising environment. Media channels continue to fragment, and audiences may be elusive. The objective of reaching consumers with a consistent message across multiple points of contact may come in the midst of advertising/marketing budget limitations and intense competition. These challenges occur while an emerging medium, the Internet, has attracted advertising dollars from major marketers.

Historical models are sometimes used to assess effectiveness of advertising. Historical models may be used, for example, to model the number of sales of a product over a period of time (such as 3 to 5 years). Historical models may provide information on the effects of macro factors, which may be considered at a total population level and over a long period of variation. Nevertheless, historical models often may not provide a sufficient level of information regarding particular consumer segments. One reason as that, over the time period evaluated in the historical model, the proportion for a consumer segment (for example, women, or over-65s, or cable television viewers) may be relatively static, and there may not be sufficient variation in the data to see the effect of changes. In addition, graphical information (for example, response curves) produced by computer systems from such historical models may be of limited value.

### SUMMARY

In an embodiment, a method includes collecting individual-level data (for example, survey data) corresponding to each of one or more individuals who has been exposed to advertising for a product or service. A model may be created based on factors relating to acquisition of the product or service. A response to the advertisements is assessed based on the model. In some embodiments, intermediate measures to sales are included in the model.

In an embodiment, a system includes a processor and a memory, the memory being coupled to the processor and storing program instructions executable by the processor to implement a method that includes collecting individual-level data (for example, survey data) corresponding to each of one or more individuals who has been exposed to advertising for a product or service. A model may be created based on factors relating to acquisition of the product or service. A response to the advertisements is assessed based on the model. In some embodiments, intermediate measures to sales are included in the model.

In an embodiment, a tangible, computer readable medium comprising program instructions stored thereon, wherein the program instructions are computer-executable to implement a method that includes collecting individual-level data (for example, survey data) corresponding to each of one or more individuals who has been exposed to advertising for a product or service. A model may be created based on factors relating to acquisition of the product or service. A response to the advertisements is assessed based on the model. In some embodiments, intermediate measures to sales are included in the model.

In an embodiment, a method includes obtaining aggregate data for a population that has been exposed to advertisements for a product or service, and obtaining individual-level data corresponding to individuals who have been exposed to advertisements for the product or service. A historical model may be created based on the aggregate data. An individual-level model may be created based on the individual-level data. A measure of effectiveness of the advertisements may be determined based on the historical model and the individual-level model. In some embodiments, the historical model and the individual-level model are integrated with one another. In certain embodiments, the historical model is adjusted based on the individual-level model.

In an embodiment, a system includes a processor and a memory, the memory being coupled to the processor and storing program instructions executable by the processor to implement a method that includes obtaining aggregate data for a population that has been exposed to advertisements for a product or service, and obtaining individual-level data corresponding to individuals who have been exposed to advertisements for the product or service. A historical model may be created based on the aggregate data. An individual-level model may be created based on the individual-level data. A measure of effectiveness of the advertisements may be determined based on the historical model and the individual-level model. In some embodiments, the historical model and the individual-level model are integrated with one another. In certain embodiments, the historical model is adjusted based on the individual-level model.

In an embodiment, a tangible, computer readable medium comprising program instructions stored thereon, wherein the program instructions are computer-executable to implement a method that includes obtaining aggregate data for a population that has been exposed to advertisements for a product or service, and obtaining individual-level data corresponding to individuals who have been exposed to advertisements for the product or service. A historical model may be created based on the aggregate data. An individual-level model may be created based on the individual-level data. A measure of effectiveness of the advertisements may be determined based on the historical model and the individual-level model. In some embodiments, the historical model and the individual-level model are integrated with one another. In certain embodiments, the historical model is adjusted based on the individual-level model.

In an embodiment, a method includes obtaining individual-level data corresponding to individuals who have been exposed to one or more advertisements for a product or service. From the individual-level data, a multivariate regression model is created based on factors relating to acquisition of the product or service. The multivariate regression model may include two or more variables. A response to the advertisements based may be assessed based on the model.

In an embodiment, a system includes a processor and a memory, the memory being coupled to the processor and storing program instructions executable by the processor to implement a method that includes obtaining individual-level data corresponding to individuals who have been exposed to one or more advertisements for a product or service. From the individual-level data, a multivariate regression model is created based on factors relating to acquisition of the product or service. The multivariate regression model may include two or more variables. A response to the advertisements based may be assessed based on the model.

In an embodiment, a tangible, computer readable medium comprising program instructions stored thereon, wherein the program instructions are computer-executable to implement a method that includes obtaining individual-level data corresponding to individuals who have been exposed to one or more advertisements for a product or service. From the individual-level data, a multivariate regression model is created based on factors relating to acquisition of the product or service. The multivariate regression model may include two or more variables. A response to the advertisements based may be assessed based on the model.

In an embodiment, a method includes creating a model having one or more econometric factors. Data relating to individual consumer attitudes or individual consumer behaviors is received into the model. Based on the econometric data, a measure of the individual consumer attitudes and/or the individual consumer behaviors is calibrated.

In an embodiment, a system includes a processor and a memory, the memory being coupled to the processor and storing program instructions executable by the processor to implement a method that includes creating a model having one or more econometric factors. Data relating to individual consumer attitudes or individual consumer behaviors is received into the model. Based on the econometric data, a measure of the individual consumer attitudes and/or the individual consumer behaviors is calibrated.

In an embodiment, a tangible, computer readable medium comprising program instructions stored thereon, wherein the program instructions are computer-executable to implement a method that includes creating a model having one or more econometric factors. Data relating to individual consumer attitudes or individual consumer behaviors is received into the model. Based on the econometric data, a measure of the individual consumer attitudes and/or the individual consumer behaviors is calibrated.

### BRIEF DESCRIPTION OF THE DRAWINGS

FIG. 1 is a block diagram illustrating a modeling approach that integrates a historical model with an individual-level model.

FIG. 2 illustrates one embodiment of assessing advertising effectiveness using individual-level modeling.

FIG. 3 is an example structure for a model for assessing long term effects of marketing.

FIG. 4 illustrates one embodiment of an assessment of advertising effectiveness based on multivariate regression modeling.

FIG. 5 is a graph illustrating sales as a function of time for a pooled model.

FIG. 6 illustrates one example of a set of media response curves for a campaign.

FIG. 7 shows an example of two possible levels of base sales.

FIG. 8 illustrates how a response curve for a particular media type can change with a change in base sales level.

FIG. 9 shows an example of optimal laydowns for two different levels of spend for a particular pattern of base sales.

FIG. 10 illustrates an example of an annual response curve based on a curve fit.

FIG. 11 illustrates one embodiment of a breakdown for television.

FIG. 12 illustrates one embodiment of assessing effectiveness of advertising using a combination of a historical model and an individual-level model.

FIG. 13 is a graph illustrating one embodiment of linking together historical model output and individual level model output.

FIG. 14 is a graph illustrating relative power between media channels for a propensity to buy.

FIG. 15 is a graph illustrating response curves for different sub-channels.

FIG. 16 illustrates one example of an optimized media response curve.

FIG. 17 illustrates one embodiment of using models for generating marketing effectiveness assessments for multiple brands and for multiple consumer segments.

FIG. 18 illustrates one embodiment of a system with which assessments of advertising and marketing effectiveness may be performed over a network.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF ILLUSTRATIVE EMBODIMENTS

As used herein, an “action” means an act, selection, process, communication, task, or step that can be performed, completed, or achieved by one or more persons.

As used herein, “aggregate-level data” means data that relate to two or more persons.

As used herein, “cross-sectional data” includes data that provides information for a measure of interest for two or more different individuals, or for two or more sets or groups of individuals, such as a consumer segment or demographic. Cross-sectional data may be for a specific time period. In some cases, cross sectional information may not measure changes over time within the period being evaluated. For example, if the specific time period for the cross-sectional data is the week of Jan. 5-11, 2009, then the cross-sectional data may not provide any information distinguishing events or conditions on Jan. 5, 2011 (the first day of the period) from events or conditions on Jan. 11, 2011 (the last day of the period.)

As used herein, “explanatory variable” is a variable that at least partially explain, or is intended to explain, a response or behavior of a dependent variable.

As used herein, “feedback” means information including a critique, a comment, rating, ranking, recommendation, or suggestion relating to an action that has been taken or may be taken.

As used herein, “individual-level data” means data that relates to one or more particular individuals. Individual-level data may include particular data for each of two or more persons. For example, for a television show aired during a specific time period (for example, the month of October), individual level data may include the number of times Person A viewed the show during the time period, the number of times Person B viewed the television show during the time period, and so on.

As used herein, “individual-level model” means a model that is based on individual-level data. In some embodiments, an individual-level model is cross-sectional. The individual-level model may explain how a variable changes across a consumer segment and with exposure to particular media channels. In some embodiments, an individual-level model is based on survey data collected from one or more individuals.

As used herein, “intermediate variable” means a variable that depends, at least in part, from one or more other variables (such as an independent variable), and from which one or more dependent variables at least partially depend.

As used herein, “historical data” is data that provides information about one or more measures of interest over time.

As used herein, “historical model” means a model based on historical data. A historical model may report values of one or more dependent variables as a function of one or more independent variables or one or more explanatory variables over time. In some embodiments, a historical model explains how sales vary over time based on or more independent variables, such as media investment.

As used herein, a “model” includes a description of a system. A model may use mathematical concepts and language. A model may measure, report, or predict the value of one or more dependent variables (such as sales of a product) as a function of one more other variables (such as the number of times a commercial was aired).

As used herein, a “marketing mix model” means a model that measure the effects of marketing over a given period or across different demographic groups.

As used herein, a “media response curve” includes a curve that represents the relationship between an input, such as media investment, and a return corresponding to the input.

As used herein, a “participant” includes any person or group of persons accessing or using a system.

As used herein, a “specific time period” means a specific period in time or point in time. In some embodiments, a specific period in time is a particular week, such as the week of Jan. 5, 2009 through Jan. 11, 2009. In certain embodiments, a specific period in time may correspond to a specific moment in time (at or about 10:00 am on Jan. 5, 2009) or a particular event or portion of an event (the showing of a particular episode of ER, or the first quarter of Superbowl 38).

As used herein, “standard” means an established model or manner for performing an action or procedure. A standard may, in some embodiments, include a best practice.

As used herein, “standard procedure” means a procedure that conforms to an established or model manner of performance. In some embodiments, a standard procedure is a standard operating procedure of a particular organization. The standard operating procedure may be established, for example, in a company manual, a company handbook, or by a standards organization for an industry.

As used herein, “subgroup-level data” means data that relates to a sub-group of individuals. For example, a subgroup may be a sub-group with a total population. Examples of sub-groups include a consumer segment or demographic, such as males between 13-18 years of age. In some embodiments, subgroup-level data is based on individual-data for the individuals in the sub-group.

As used herein, a “system” includes a social system, such as a group of individuals, a community, or a population of consumers; a physical system, such as broadcast network system or a computer network; or combinations or aggregations of one or more physical and/or social systems.

In some embodiments, assessing advertising effectiveness includes collecting individual-level data (for example, survey data) corresponding to each of one or more individuals who has been exposed to advertising for a product or service. A representative sample is created from the individual-level data. A model may be created based on factors relating to acquisition of the product or service. A response to the advertisements is assessed based on the model. In some cases, intermediate measures to sales are included in the model (attitudinal, behavioral, brand imagery, familiarity, brand consideration and purchase consideration.)

In some cases, aggregate level models (“macro”) are compared to, or integrated with, individual level modeling (“micro”). For example, a macro-level model for predicting sales may be adjusted by inputs from a micro-level model (for example, an individual level model).

In some embodiments, historical data and individual level survey data are combined into a model system of sales and other attitudinal/behavioral responses. The model system may be used to produce empirical parameters for optimization of media budget.

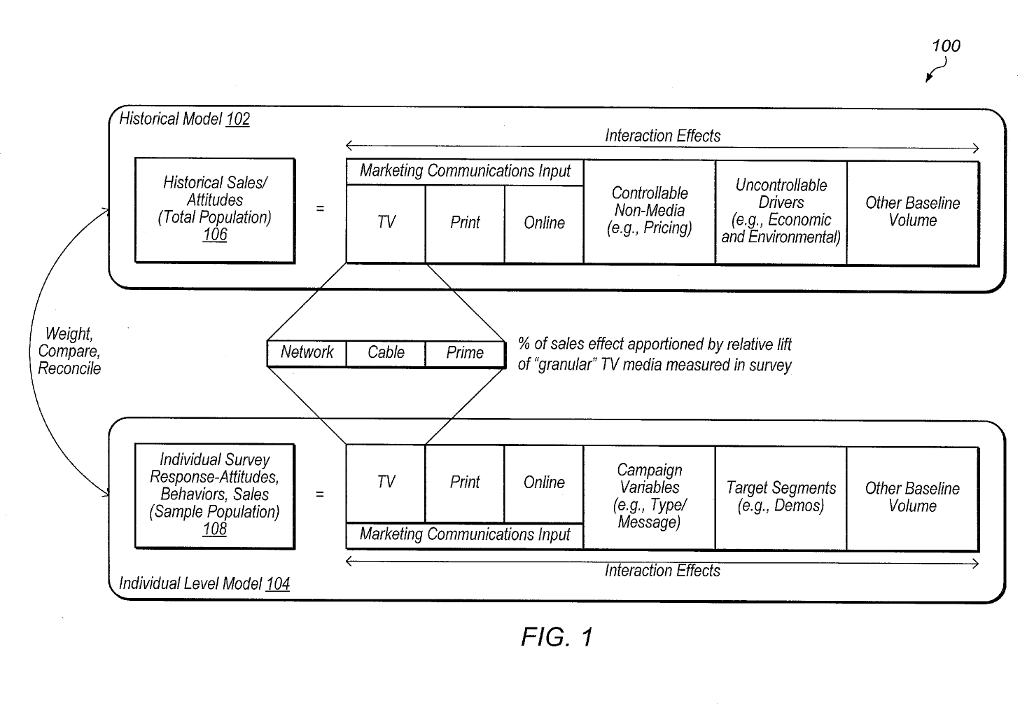

FIG. 1 is a block diagram illustrating a modeling approach that integrates a historical model with an individual-level model. Integrated model 100 includes historical model 102 and individual-level model 104. Historical model 102 includes aggregate data 106. Aggregate data 106 may include sales and attitudes data for a total population. Individual-level model 104 includes individual survey response data 108. Individual response data 108 may include survey data acquired from individuals in a population. Individual response data 108 may include data relating to attitudes, behavior, or sales for a sample population.

In various embodiments, historical model 102 and individual level model 104 may be compared, reconciled, and/or weighted. Reconciling the models may include, for example, adjusting a historical model based on an individual-level model.

In some embodiments, historical modeling is performed first (as the survey data is gathered). The historical model may be, for example, historical marketing mix modeling. As survey data is gathered, individual consumer data may be used as the basis of the individual-level modeling.

The historical model and the individual level model may each have specific role in the model system. In some embodiments, a historical model serves as a base model for predicting sales. The historical model may be adjusted by inputs from the individual model.

### Data

In some embodiments, advertising effectiveness is assessed using multiple categories of data. In one embodiment, categories of data include:
1) Marketing communication
2) Additional factors (such as pricing, product attributes, economic and environmental variables that need to be controlled for in the model)
3) Outcome variables (which may include measures of behavioral variables such as website visits, sales, as well as individual attitudes and propensities towards the brand/models, some of which may be considered intermediate variables).

Within each of these data categories, data streams may be used from historical data and survey data, including detailed information from individual respondents. From each of the data streams, data relevant to some or all product models may be extracted. The level of granularity and accuracy may vary across data streams.

Data sources may be transformed and stored in the most granular level manageable to allow flexibility to aggregate in different ways for the models.

In some embodiments, advertising effectiveness is assessed based on historical data and survey data. Some examples of historical data and survey data that may be used in assessing advertising effectiveness are described below.

### Historical Data

In some embodiments, historical data includes data for past marketing communication spend and sales, which may be available from advertising and marketing agencies. In addition, historical data, such as economic and environmental variables, may be available from various public sources. In some embodiments, data sets are refreshed as models are updated. In some embodiments, data sets and models are updated automatically. Examples of historical data are provided below:

### Historical: Marketing Communication Inputs

Media spend, gross ratings points (“GRPs”), and television ratings points (“TRPs”)/impressions may be provided for several years past (for example, 6 years). Long term media lag effects on sales may be incorporated into the model. Impressions/TRPs and media net cost may be included to ensure measuring response to media weight levels year over year.

Examples of media that may be used for optimization include:
1. TV (Spot, Network & Cable)
2. Print (Newspapers & Magazines)
3. Radio
4. Digital (FEP, Email, Social & Search)
5. In-theater
6. Out of Home/Outdoor
7. Direct Mail
8. Ongoing Sponsorship Spends

For each of the media, the following data may be included for each week with a time period:
1) Week (Monthly, or Start/End requested where weekly not available)
2) Market designated market area (DMA) where applicable
3) Campaign—name of the advertising campaign
4) Client—the sponsor of the campaign
5) Model (or product line associated with the campaign)
6) Spend (Total Gross Cost, Total Net Cost)
7) Impressions for Adults 18+ or TRPs for Adults 18+
8) Creative ID/Ad IDs (mapped to campaign and message type)
9) Planning Target (mapped to campaign)
   Historic: Additional Factors (Explanatory Variables)—such as Economic, Environmental, Pricing, Product Attributes, and Competition

Data on various non-media variables, such as economic, environmental, competitive variables may be collected. The data may be used to explain historical baseline sales (for example, sales with zero marketing spend), as well as other historical attitudinal metrics. Explanatory variables may be available for any of various periods (such as weekly, monthly, quarterly, annually) and for each individual DMA. Some explanatory variables may be attached to all DMAs or to all weeks in the year (for example, if the explanatory variables are available yearly).

Examples of economic/environmental variables include:
1) Dow Jones index
2) Gas prices
3) Unemployment
4) Inflation
5) Consumer Confidence Index
6) US Population Size
7) Weather

Examples of competitive variables include: (automotive manufacturer is used as example)
1) New car buyer population
2) Vehicle Production (# units made for sale)
3) Model Level Inventory/Days to Turn
4) Dealer Associations & Local Dealer Spend
5) Incentives—Spend (dollar amount) & Type (Nature of Offers)—Consumer and Dealer
6) Dealer Densities
7) Inherent Model Appeal
8) Vehicle model age/redesign calendar
9) MSRP (Retail Price)
10) Consumer Price
11) Loyalty Related
12) PR Impressions (positive and negative)—(potentially a marketing communication input)
13) Dealer Lead Conversion Rates
14) Dealer Satisfaction
15) Competitive Media Spend

### Historic: Outcome Variables—for Example, Sales

In one embodiment, two or more sources of data for historical sales are available. As an example, in the automotive sales field, data may include:
1) Historical new vehicle registration data, such as may be available from Polk. Vehicle registration data may be available on a monthly level, and can be pulled for each market for each car model. This data source can have competitor sales data, but limited target demographic data. Additional data may be available to integrate for additional demographic information.
2) Historical new vehicle sales data from a customer relationship management (“CRM”) database. CRM database data may be available, for example, from a marketing and advertising agency. The CRM database may include sales information for each individual who bought a particular product. Weekly Sales data by target demonstrations may be available for the analysis period.

| Data | | | | Time | |
|---|---|---|---|---|---|
| type | Variable | Units | Time | Range | Geography |
| Success | Sales - Polk | Number | Monthly | September | Tier/ |
| Metrics | Registrations | | | 2003- | DMA |
| (Final) | | | | September | |
| | | | | 2008 | |
| Success | Sales - | Individuals | Time of | September | Tier/ |
| Metrics | Agency | | Sale | 2003- | DMA |
| (Final) | CRM | | | September | |
| | | | | 2008 | |

### Historic: Outcome Variables (Intermediate)—Attitudinal Metrics

In some embodiments, brand and model funnel metrics may be tracked by way of a syndicated survey product. In an initial historical model, data is used as a measure of attitudinal funnel metrics. Metrics may be available as a single data point per month.
1) Awareness
2) Familiarity
3) Consideration
4) Purchase Intent.
5) Share of Shops, etc.
6) Key Image Attributes

### Historic Outcome Variables (Intermediate)—Such as Shopping Actions

There are several intermediate variables that may be modeled from other input variables (media input variables, explanatory variables), while simultaneously acting as inputs for Sales. Examples of variables include:
search volumes on brand terms
website traffic (measured by visits, unique visitors and complete actions)
buzz

### Survey Data

In some embodiments, survey data is used to analyze patterns related to detailed media exposure, demographics and attitudes/propensities towards client brands. Weekly sample sizes may be large, and may be selected to broadly cover an entire marketplace (for example, all consumer segments and marketing activity), with oversamples in areas of known interest. A survey plan may include interviews of a very broad base nationally representative, for example, English speaking Adults 18+ new vehicle intenders.

Survey data for each individual may include information covering these areas:
1. Demographics
2. Brand Metrics
3. Model Metrics
4. Ad Diagnostics
5. Media Consumption Data
6. Ongoing Longitudinal Capture Shopping Patterns

After an initial interview, individuals may be re-contacted and their path to purchase profile may be re-surveyed. A re-survey may indicate, for example, if an individual has moved closer to a purchase decision (or have purchased).

In some embodiments, a survey and sample structure may be used to capture information on 1) exposure frequency to all different marketing communication channels 2) attitudes/intentions about brands and models; and 3) demographic traits. A re-contact may be used to capture a longitudinal pattern of the purchase consideration process. These data may be used to model the effects of media on a consumer's path to purchase.

In some embodiments, a re-contact structure is implemented such that the same individuals are interviewed at predefined intervals, (for example, every 90 days). Such re-contacts may be used to identify, for example, an individual's additional media exposure, attitude shifts and shopping behavior.

### Individual-Level Modeling

In some embodiments, marketing mix models are derived from historical data. The marketing mix models may be based on regression equations. The models may be used to statistically identify and size drivers of a sales response. In some embodiments, actual sales volume or other market-based outcomes are predicted based on aggregate, market-level drivers. Such drivers may include, for example, media spending, price points, and general economic/environmental factors. In some embodiments, the model output is used to optimize media spend.

In some embodiments, individual consumer survey techniques and analysis are used to provide granularity and explanatory information. Individual consumer survey analysis include collecting and assessing variation of responses across customer groups, impact of media types, creative effectiveness, path-to-purchase patterns, and attitudinal and behavioral self-reports. In some embodiments, survey analysis is reconciled back to a wider market/population and historical sales data.

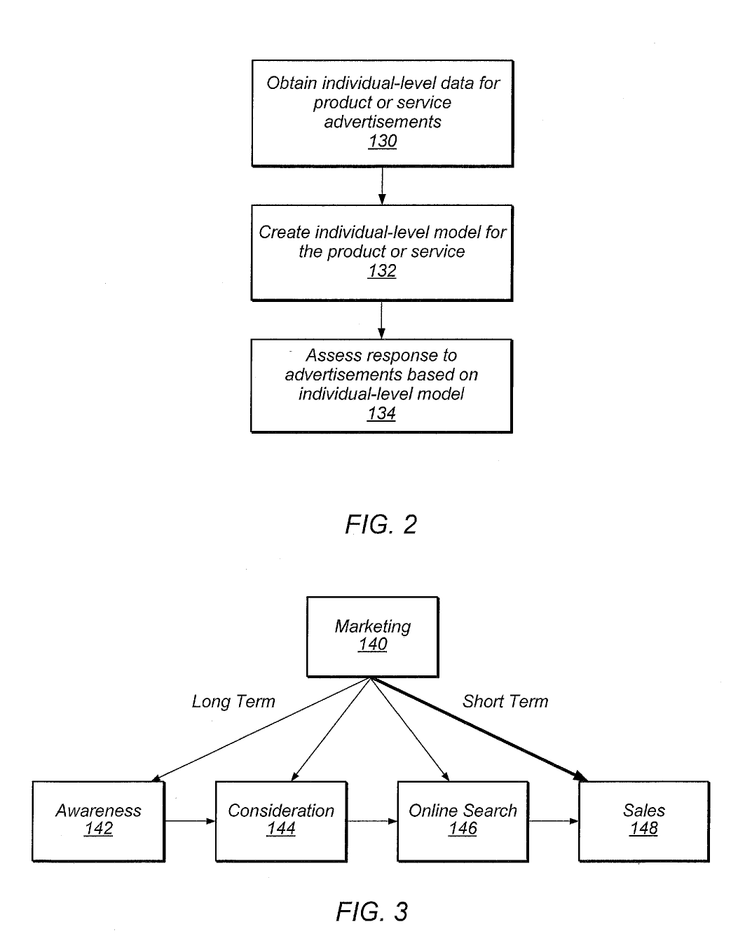

FIG. 2 illustrates one embodiment of assessing advertising effectiveness using individual-level modeling. At 130, individual-level data is obtained that corresponds to each of one or more individuals who has been exposed to one or more advertisements for a product or service. In some embodiments, individual-level data is acquired from individual surveys of one or more individuals. In some embodiments, a representative sample from the individual-level data is determined for one or more of the individuals.

At 132, an individual-level model is created based on one or more factors relating to acquisition of the product or service. The model may describe at least one dependent variable as a function of one or more other variables for a particular period in time. The variables may include, in various embodiments, one or more independent variables, one or more intermediate variables, or combinations of one or more independent and/or intermediate variables.

At 134, a response to one or more of the advertisements for the product or service is assessed based on the individual-level model.

In some embodiments, data for a representative sample of individuals is gathered through surveys, directly tracked behaviors, or a combination thereof. The data from surveys can be used to build models. The models may be used to analyze how different consumer segments respond to marketing. Key drivers may be identified from the analysis. In some embodiments, individual level modeling is used for prescriptive marketing strategy intelligence and tactical insights.

In some embodiments, individual level modeling is cross-sectional. The individual-level model may consider influence of one or more explanatory variables. Such explanatory variables may include, for example, age, sex and income. A model may determine whether a person will buy a particular product or service based on one or more of the explanatory variables. Explanatory variables may also be used to determine responsiveness to marketing communication.

In some embodiments, an individual-level model is used to determine a relationship between the way in which a person consumes media and the person's propensity to buy. For example, people who are exposed to more TV ads on cable TV viewers may have a greater propensity to buy a certain car than otherwise identical people who predominantly consume network TV (e.g., media and customer segment interactions). In some embodiments, a relationship is established between a sample group and a general population. An estimate may be made of the effect of increased propensity to buy on incremental sales based on the relationship.

In one embodiment, respondents participate in surveys that inquire into path to purchase behavior and attitudes (such as web-site visits and likelihood to purchase). Each individual respondent in survey may provide a complete set of responses. The respondents may participate in the surveys across a multi-year study period. A subset of the respondents may complete a re-contact survey that determines actual, recent, purchase, and movement through a path-to-purchase. In some embodiments, the survey provides purchase behavior as the primary outcome.

In some embodiments, the outcome is binary in nature. For example, the outcome may be Yes/No for whether or not the respondent made a purchase. The corresponding model may be a binary response model. In some embodiments, an individual-level model includes a logistic regression model. In the logistic regression model, the estimated outcome may be a probability of purchase (instead of, for example, total sales units). The probability of purchase may be converted into a number of units and then weighted back to total observed sales through volumetric analysis of the market and the sample population.

In some embodiments, drivers of sales propensity at an individual consumer level are used in the evaluation of different marketing levers for different consumer groups, geographies, or other grouping. Effects of marketing levers may be assessed by consumer segment, socio-economic group, or any of various other categories.

### Intermediate Measures

In some embodiments, historical model and individual-level models include explanatory variables and outcome variables. An outcome variable may be a dependent variable, such as actual sales. The explanatory variables may be used to explain what drives an outcome variable.

In some embodiments, a historical model or an individual-level model includes intermediate measures. The intermediate measures may be used in a historical model, an individual-level model, or both. The intermediate measures may be used to measure purchase process variables.

In some embodiments, intermediate measures capture a consumer's attitudes and behaviors related to the brand/nameplates. Intermediate measures may provide information beyond whether a consumer did or did not buy a certain product (measures of actual sales). In some embodiments, inferences are made about linkages between and among marketing activities, changes in consumer attitudes and beliefs, and resulting sales. Examples of intermediate measures include brand imagery, familiarity, brand consideration and purchase consideration. Other examples of intermediate measures include specific behaviors that may drive a subsequent purchase, such as web search.

In some embodiments, intermediate measures are included as explanatory variables. In one embodiment, intermediate measures are included as explanatory variables directly in a sales model. In certain embodiments, intermediate modeling is used to assess advertising effectiveness in markets for highly considered purchases (such as cars) where purchase cycles may be relatively long (for example, from 3 to 7 years).

In some embodiments, intermediate models are evaluated and integrated with a sales model by testing different fits and structures. For example, an individual piece of advertising may have an impact on brand awareness for some individuals, drive brand consideration for other individuals, and be the final persuasion needed to choose one brand over another for still other individuals.

A determination of which measures to include in a model(s) may be investigated during the modeling process. For example, for a historical model in which the analysis is focused on changes in sales over time, movements in key intermediate measures may be investigated to understand which measures have undergone significant movements over time.

### Intermediate Models

In some embodiments, intermediate models include as dependent variables and as explanatory variables one or more of the following factors: path to purchase behaviors (such as a visit to dealership, a visit to website), attitudes (such as likelihood to consider, likelihood to purchase), brand imagery (e.g. positive imagery for safety, affordable, etc), or combinations thereof. Based on the models, an assessment may be made of how well brand perceptions, media and message types ultimately impact behavior (e.g. visit to web site).

In some embodiments, the long and short term effects of marketing activities are quantified in a multi-outcome modeling structure. One example of a methodology that may be used to assess long term effects and short term effects of marketing is provided below.

### Short Term Effects:

Short term effects of marketing may be the impact of marketing messages at directly influencing a sale. Within the model structure, short term effect can be set out as the simple direct relationship between sales and marketing through any given channel:

Marketing Investment→Sales

Quantification of the short term effect of each marketing channel may be based on a direct causal relationship for each model.

### Long Term Effects

In some embodiments, long term effects of marketing are quantified in a multi-stage process. In one embodiment, long term effects through the relationships between marketing, attitudinal and pre-sale behavioral measures and the ultimate metric of interest: sales. For example, a model system may include the following set of key outcome variables: awareness, consideration, online search and sales. FIG. 3 is an example structure for a model for assessing long term effects of marketing. Marketing data 140 may be fed into models that assess long term measures including awareness 142, consideration 144, and online search 146. Marketing data 140 may be fed into models that assess short term measures including sales 148. Some or all of long term measures awareness 142, consideration 144, online search 146 may be used in a model to assess the effectiveness of advertising on sales 148.

In some embodiments, a time-lagged relationship is determined between two or more modeled variables. For example, an increase in awareness may drive an increase in consideration, but not until a few months later. In this example, marketing activity that only drives awareness may be expected to have a more long term impact on sales. It may take several months/years, for example, for the sales effect to become evident. In certain embodiments, data is evaluated for adstock effects. Advertising may have an impact for sometime following the marketing activity, in addition to the time the campaign is on air.

In this example, there may be three pathways by which marketing can influence sales in the longer term: by driving awareness, consideration and visits to website. In one embodiment, long term causal pathways by which marketing affect sales may be determined based on the following causal chains:
1. Marketing→Awareness→Consideration→Visits to website→Sales
2. Marketing→Consideration→Visits to website→Sales
3. Marketing→Visits to website→Sales

In some case, not all marketing channels will have a significant effect on all intermediate outcomes. Multistage modeling may nevertheless improve understanding the impact of each individual channel, for example, by breaking potential impact into different stages.

### Synergistic Interactions

In some embodiments, synergistic interactions are determined between different media channels, between different messages, or both. In one embodiment, synergistic interactions are tested in a sales model and in an intermediate model.

In some embodiments, an evaluation is made of where marketing interactions are planned to occur and where marketing interactions would be expected to occur. Results from the individual-level models may be used to identify whether individuals who were exposed to both messages responded more strongly than would be expected than those who were exposed to just one of the messages. In such cases, the total effect may be greater than the sum of the individual effects.

In one embodiment, it is assumed that there are no interactions unless an interaction is specifically identified through the creation of an interaction variable. If the variable fits into the model, the additional return generated through using both channels together may be calculated. In some embodiments, a determination is made whether a bonus effect or multiplier exists when multiple media or messages are used together.

In various embodiments, individual-level modeling is based on multiple point-in-time measures. In some embodiments, an individual-level model uses an isolated impact of advertising on one or more measures of marketing, such as awareness, brand perception, purchase consideration, or other measures, at multiple points in time.

In some embodiments, individual level modeling includes and initial survey and at least one follow-up survey at a later point in time. A calculation may be performed to determine the extent to which awareness, brand perceptions, purchase consideration, or other measures convert to sales for one brand or another. Having multiple point-in-time measures of disposition to a brand allows for additional modeling of the ways in which exposure to different advertisements, messages, media weight, pricing, external economic factors, and other factors explain changes in brand disposition.

### Regression Modeling

In some embodiments, a model incorporates regression modeling. Regression methods may be used to test different combinations of explanatory variables. In some instances, output from regression models is a simple equation in which the different variables included add together to explain the total sales. Effects of a particular variable may be consistent throughout the modeling period. For example, 5% off list price or $500 k spend on TV may generate the same number of additional sales regardless of what other activity is taking place.

In some embodiments, a multiplicative model is used to assess advertising effectiveness. The multiplicative model may allow for varying responsiveness of advertising depending one or more factors other than media spend that might drive sales (for example, pricing and media) to be taken into account. For example, 5% off list price for a product might generate a larger increase number of sales when gas prices are low than when gas prices are high.

In some embodiments, impact of any given factor on sales at a specific point in time is a function not only of the size of the factor at that point in time but also the size of all the other factors included in the model. For example, the size of the sales impact of a price promotion in a given month might be driven primarily by the size of the discount from list price, but the size of impact of a price promotion may also be driven by all other variables in the model. For example, the size of impact of a price promotion may vary with the state of the economy, gas prices, the amount of advertising, or combinations of one or more of these factors.

In certain embodiments, multivariate models are supplemented with measurement of media multiplier effects from individual-level models.

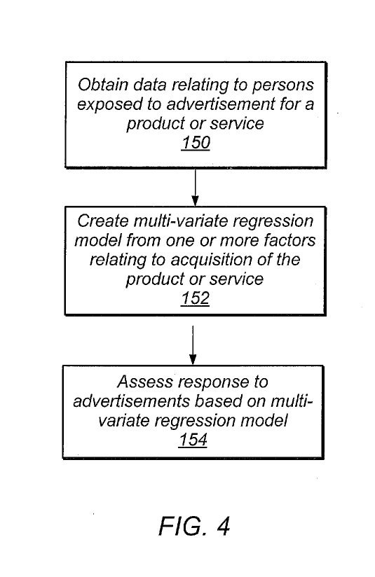

FIG. 4 illustrates one embodiment of an assessment of advertising effectiveness based on multivariate regression modeling. At 150, data is obtained relating to one or more persons who have been exposed to one or more advertisements for a product or service. In some embodiments, the obtained data includes data that corresponds to each of one or more individuals who have been exposed to one or more of the advertisements.

At 152, from the individual-level data, a multivariate regression model is created based on one or more factors relating to acquisition of the product or service. The multivariate regression model may include two or more variables affecting sales. In some embodiments, the variables affecting sales include two or more intermediate variables. At 154, a response to the advertisements is assessed based on the model.

### Historical Models and Individual-Level Models

In some embodiments, one or more historical models and one or more individual-level models are integrated. An integrated model may account for the macro impacts from the environment, as well as more granular impacts resulting from different messaging and target strategies.

In one embodiment, campaign objects are reviewed to determine instances in which interactions are intended. Data may be cross-plotted to identify correlations and possible collinearity issues. In some embodiments, possible interactions are ranked. A historical model may be developed. Interactions may be aligned. In some embodiments, a log model only and log model enhanced with multiplier effects are each developed. The log model only may be assessed against the log model with multiplier effects. Based on the assessment, the better model may be recommended.

In some embodiments, a historical model is considered as a macro level model and an individual-level model is considered as a micro-level model. In one embodiment, sales predictions are scaled back to the population, and matched in timing windows to the aggregated sales data to determine how predictive the individual-level sales models are. Incongruencies may be identified and models may be adjusted, for example, to improve output consistency of the historical model and the individual-level modeling.

In an embodiment, a historical model measures aggregate population (for example, overall DMA level) response to inter-media spend (for example, TV vs. Radio vs. Digital, etc). An individual-level model may measure the attribution of intra-media (for example, Network vs. Cable vs. Spot) spend on sales, at a segment specific level (for example, age segment available from a survey). Interactions may be measured in the historical model and individual-level model and integrated into the synthesis of models.

Information from individual-level models may provide a more granular level of marketing impact measurement. In some embodiments, optimization is performed at a sub-channel level.

In some embodiments, a historical model and an individual-level model serve different purposes in an integrated model system. Even in such case, however, the model results may still be compared for consistency and order of effects.

In one example of how the models might provide differing results, an individual-level model might show that newspaper advertising has almost no effect on influencing the propensity to buy, yet historical model might show a strong uplift in sales when newspaper advertising was used. Under these circumstances, alternative hypotheses may be tested in the historical model. Any incongruencies may be listed and evaluated as the models are integrated.

There are a number of reasons why results from the historical model and individual-level model might be different. For example, it might be that magazine and newspaper advertising has been used simultaneously and the incorrect variable was chosen to represent this in the historical model. Alternatively, the time period in which the individual-level model survey data was collected might have been in a period of unusually high media effectiveness when compared to a much longer time period covered by the historical model. In some embodiments, information provided by modeling with both methods is used to improve the recommendations based on the models.

### Historical Models

In various embodiments including a historical model, a model estimates how a dependent variable, such as sales, varies over time. A historical may be updated periodically (for example, weekly, monthly, quarterly, or semi-annually) to keep relationships as up to date as possible. In addition to measuring sales, measurements may be taken for what is considered to be the driving forces behind the sales. Explanatory variables may be measured in the same periods and with the same frequency of measurement as dependent variables.

In some embodiments, a historical model includes both time and geographic dimensions by which to explain the performance of marketing investment. For example, to provide the most possible variation in the relationship between sales, media and additional external variables (e.g. seasonality, demographic composition, incentives, etc.) data may be gathered at the DMA (Designated Market Area) level across different time periods. The historical model may be developed for a period of any duration, including monthly or weekly data. Some intermediate models may be built at the weekly level, since data may be available and reliable at that level (for example, search and website traffic). Annual sales estimates may be determined by aggregating estimates across the time periods (for example, 12 monthly periods).

The dimensions of a tiered approach to modeling across geographies may be based on an analysis of tier-level data for each set of variables: sales, intermediate outcome variables (attitudinal, behavioral, or both) and explanatory variables. In some embodiments, a pooled model is created to cover the relevant tiers for each model (for example, car model).

In some instances, a pooled approach is used to model simultaneously. Individual groups may benefit from the variation on other groups. In addition, if there are relatively few data points, a regression algorithm for the pooled model may be used to generate more data points. This may increase the maximum number of explanatory variables that can be used in the model.

In certain embodiments, pooled models are built across individual DMAs instead of across tiers, or to group them in a more granular way. Such an approach may result in an increase in the number of data points. An increased number of data points may make the statistical analysis even more robust, while allowing for differences in response to marketing or other input variables at the tier (market group) level to be read.

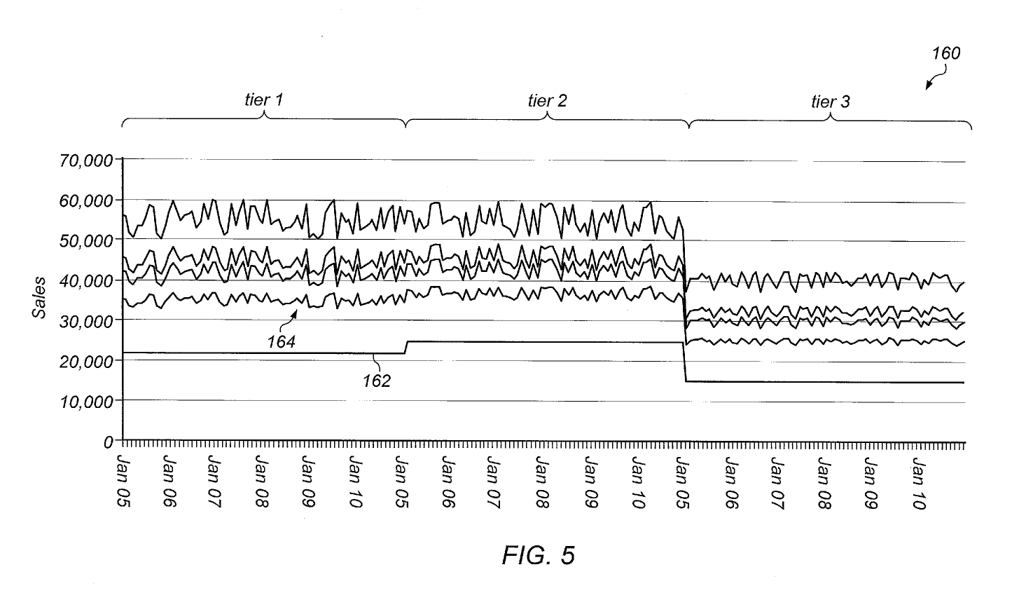

FIG. 5 is a graph illustrating sales as a function of time for a pooled model. The model may be decomposed into a base and multiple factors. Sales graph 160 includes base curve 162 and factor curves 164. Each of factor curves 164 may relate to a different factor. Factors may include, for example, price promotions, long-term branding, advertising, and gas prices. Data graphs may be reflected in tiers 1, 2, and 3.

The impact on sales that each driver had in each tier (for example, market group) may be calculated. These tiers (for example, market groups) may be used to calculate the total impact that each driver had on total sales.

In some embodiments, output from a pooled model is used to generate media response curves by tier (market groups).

In some embodiments, after historical models have been refined and adjusted, explained hold outs may be tested to determine how accurate structure of the historical model is. In one embodiment, data from several months at random in the middle or the most recent months is removed from the model to identify a range of accuracy the models are capable of predicting. This step may be performed again once the integration of the individual-level model and historical model are completed and the optimization algorithms have been developed.

### Optimization

In some embodiments, media response curves are produced using historical models and individual level models. A media response curve may be generated for each media type, each of which may behave differently.

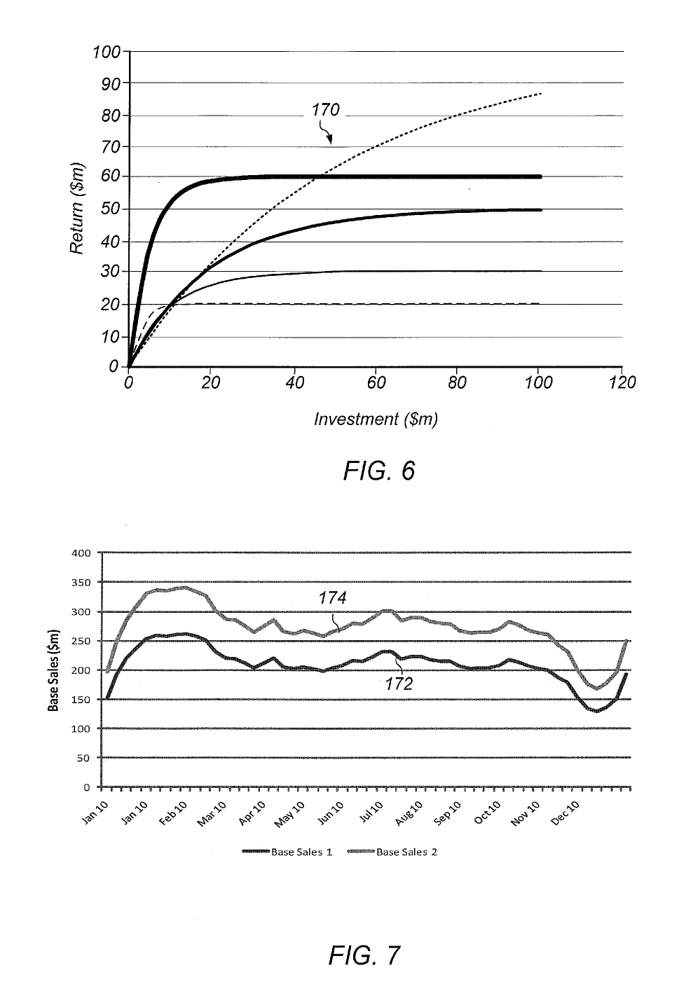

FIG. 6 illustrates one example of a set of media response curves for a campaign. Each of curves 170 may represent a response curve for a different media.

Media response curves may be created for an assumed set of environmental and external conditions. FIG. 7 shows an example of two possible levels of base sales. Curve 172 represents base sales 1. Curve 174 represents base sales 2. Different levels of base sales may be caused, for example, by changes in external factors. Such external factors may include, for example, lower gas prices or increased economic activity. In one embodiment, assumptions for environmental and external conditions may be set by a user, for example, using an integration tool.

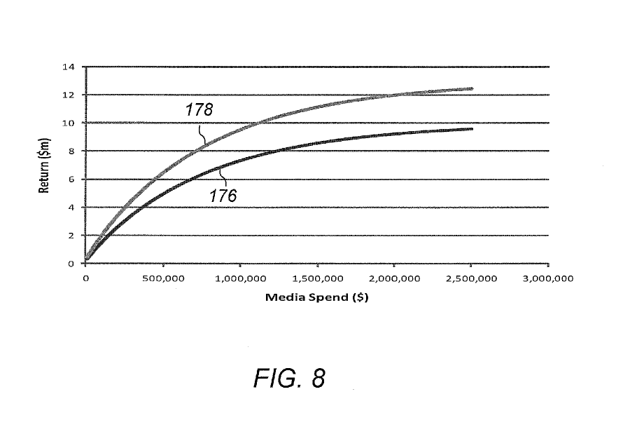

FIG. 8 illustrates how a response curve for a particular media type can change with a change in base sales level. Curve 176 is an example of a media response curve for base sales 1. Curve 178 is an example of a media response curve for base sales 2. In certain embodiments, all curves are affected in a similar way. In some embodiments, interaction between external factors and marketing investment are included in an optimization.

In some embodiments, with a representative set of curves, mathematical optimization routines are used to allocate a budget between the available media types. In some cases, it may not be necessary to add any artificial constraints to an optimization process beyond specifying a total budget. The shape of each curve may be used by an optimizer to avoid allocating unrealistic spends to any particular media type. Nevertheless, in certain embodiments, a user may override optimization recommendations and compare different scenarios (for example, using a simulation tool).

Generating Annual Curves from the Historical Models

When the historical models have been constructed and validated, monthly response curves may be converted into annual response curves. The annual response curves may be used in an optimization process. Algorithms may be used to optimize advertising budget at different spend levels, and the resulting sales impact aggregated over an annual period. Media budget may be assigned with optimal fighting in order to assess the maximum sales opportunity at different budget levels. In one embodiment, the approach accounts for factors that impact the return at a given budget level. These factors may include:
1. Carry-over impact of advertising. The advertising pressure for media/messages with a lower adstock level may decay more quickly.
2. Diminishing returns relationship. The media budget may be flighted such that it remains on the steep part of the response curve, which may avoid wasted spend in a given month at levels that have reached saturation
3. Seasonality of sales, events and marketing response. Since advertising may interact with other key factors impacting sales, a greater return may be achieved in periods where base sales are relatively high.
4. Variability of media costs. Media costs may vary dramatically over time (for example, from quarter to quarter) such that significantly more media could be bought for the same budget if the expensive periods are avoided. Even in quite seasonal markets it can be possible to take advantage of cheaper months before a sales peak provided there is sufficient carry over impact to last throughout.

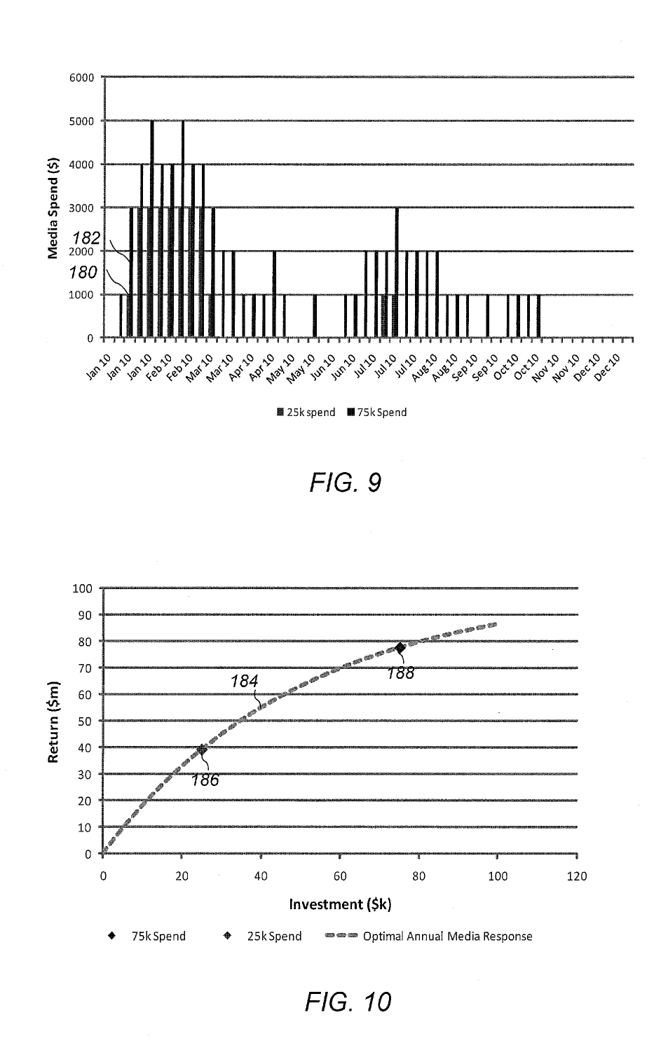

In one embodiment, maximum returns achievable are simulated across a range of spends. Annual media response curves may be constructed from curves. FIG. 9 shows an example of optimal laydowns for two different levels of spend for a particular pattern of base sales. For example, in this example, bars 180 (the left bar of each pairing) may correspond to 25K spend. Bars 182 (the right bar of each pairing) may correspond to 75K spend.

FIG. 10 illustrates two points with a curve fitted through them representing the annual response curve. Curve 184 may represent an optimal annual media response curve. Point 186 may correspond to 25K of spend. Point 188 may correspond to 75K of spend. In one embodiment, 50-100 different spend levels are simulated to provide further data points on which to fit the response curve.

Integrating Individual-Level Model Output into the Historical Model Annual Response Curves

In some embodiments, a historical model provides a view of historic performance of marketing activities in the context of other factors affecting sales (macroeconomic, competitive etc.). The historical model may provide an indication of the return from marketing activities at a topline level given assumptions around market conditions. Interactions may be captured between the external factors and the marketing impact in order to allow optimization of the media investment across a range of possible market conditions.

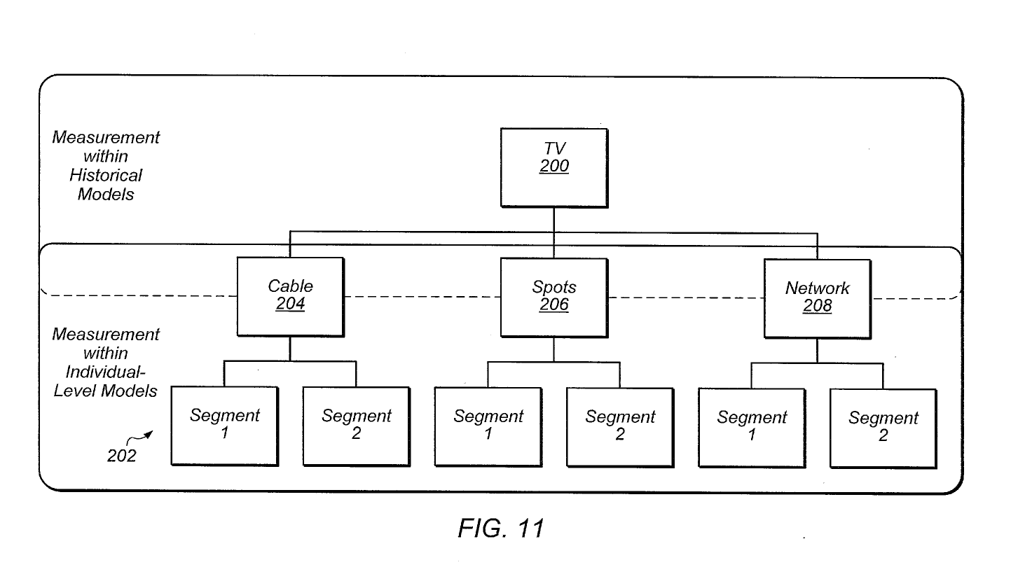

In some embodiments, individual-level models provide complementary information that is used in conjunction with a historical model. For example, a historical model may provide an expected financial payback likely by message type and media channel, while an individual level modeling may provide a detailed split of how best to spend the optimal budget within each channel and across consumer segments. FIG. 11 illustrates one embodiment of a breakdown for television. The focus for assessment at the level of TV 200 may be based on historical models. The focus for assessment at the relatively more granular level of segments 202 may be based on individual-level models. The focus for assessment at the intermediate level of sub-media channels of cable 204, spots 206, and network 208 may be based on individual-level models, historical models, or combinations of both types of models.

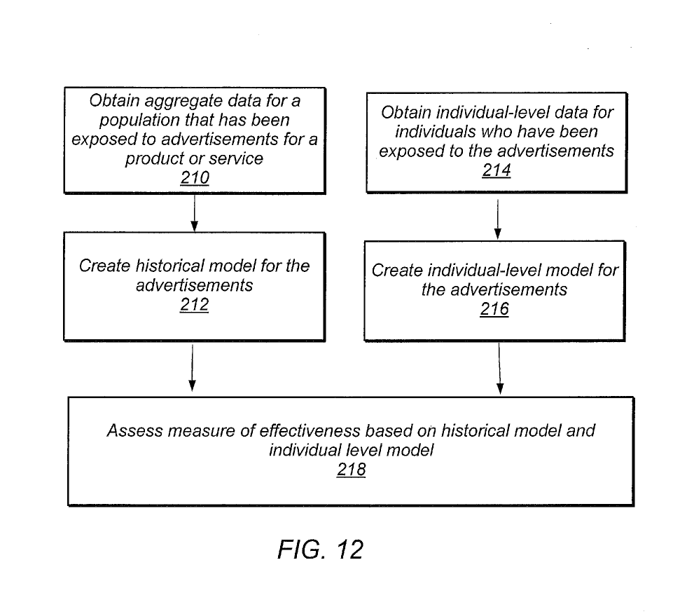

FIG. 12 illustrates one embodiment of assessing effectiveness of advertising using a combination of a historical model and an individual-level model. At 210, aggregate data is obtained for a population that has been exposed to one or more advertisements for a product or service. At 212, one or more historical models are created based at least in part on the aggregate data for the advertisements relating to the product or service. The historical models may include one or more measures of effectiveness as a function of time for at least one time period.

At 214, individual-level data is obtained corresponding to each of one or more individuals who have been exposed to advertising for the product or service. At 216, an individual-level model is created based on one or more factors relating to acquisition of the product or service.

At 218, a measure of effectiveness is determined based on the historical model and the individual-level model.

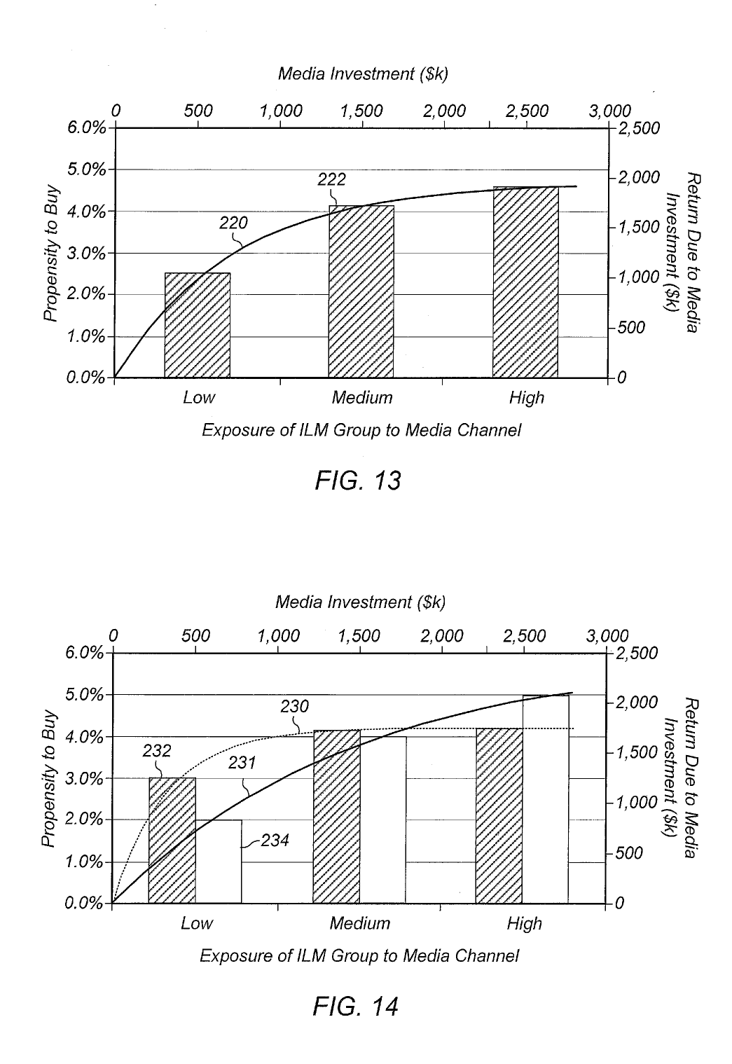

In some embodiments, a historical model and an individual-level model are linked with one another. FIG. 13 is a graph illustrating one embodiment of linking together historical model output and individual level model output. Line 220 may represent the annual response curve for television overall as defined by a historical model. Bars 222 may denote varying lift/response to different TV investment levels in terms of propensity to buy from an individual level model.

FIG. 14 is a graph illustrating relative power between media channels for a propensity to buy. Curve 230 may be a media response curve associated with network TV. Curve 231 may be a media response curve associated with spot TV. Bars 232 may represent propensity associated with network TV. Bars 234 may represent propensity associated with spot TV. Propensity to buy can be driven at varying levels for different media sub-channels, network television and spot television (at different budget levels). This relationship can be used to determine relative response curves for these sub-channels.

A historical model may capture a return on investment by channel. The historical model may also account for other macro factors such as price and seasonality. Historical models may provide the framework for the overall impact for each media channel. An individual-level model may provide more granular information on the relative power of different intra-media types within a media channel. In some embodiments, an individual level model is used to split historical model media curves into a set of intra-media.

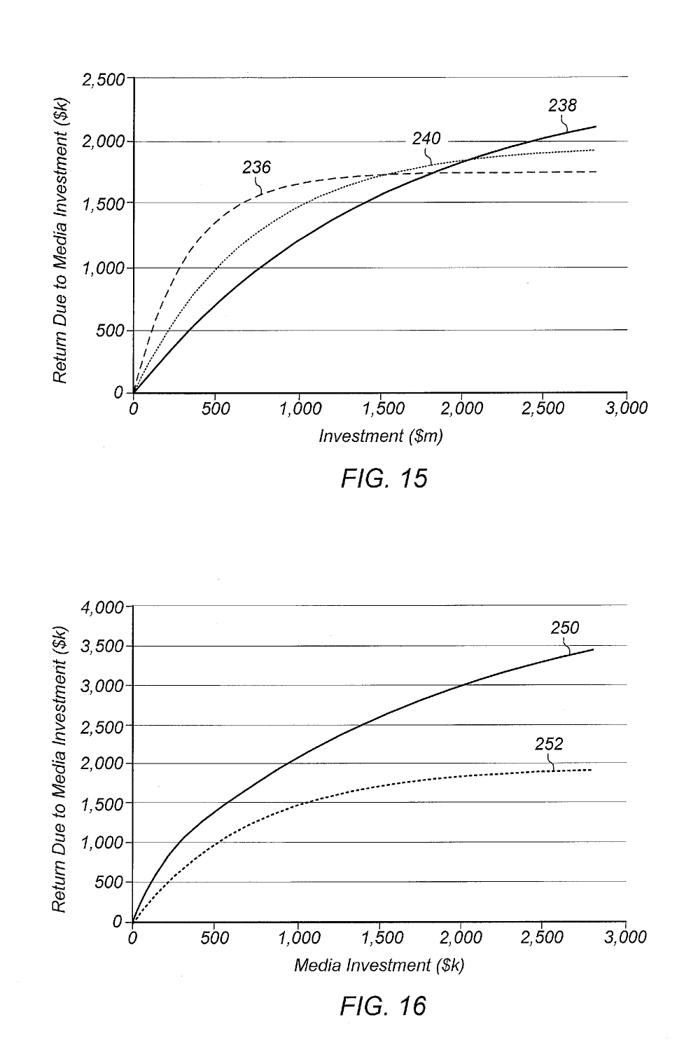

FIG. 15 is a graph illustrating response curves for different sub-channels. In this example, separate response curves 236 for Network TV and curve 238 for Spot TV may be created using individual-level models and individual-level data. Curves 236 and 238 may be constrained by the Total TV curve 240 from a historical model. The individual level models may reveal the relative effectiveness between sub-media channels. Based on this information, one media channel curve may be split into a number of sub-media curves. The sub-media curves can may be used in optimization, which may provide more granular insight on relative effectiveness and optimal spend levels across sub-channels.

In some embodiments, the results of the sub-channel analysis are used as a basis for altering media response curves derived from a historical model. The altered curves may more be used to make improvements to media allocation. FIG. 16 illustrates one example of an optimized media response curve. Optimized media response curve 250 may be derived from sub-channel analysis and historic media response curve 252.

In some embodiments, spend is optimized across sub-channel curves. More accurate and more granular sub-channel response curves may be derived from individual level modeling efforts may produce more efficient and effective budget resource allocation.

In some instances, only sparse information is available for one or more media sub-channels. In some embodiments, results are compared across models to create a curve for a sub-channel (for example, a sub-channel for which relatively little information is available). In certain embodiments, procedures described herein may also be applied for analyzing the split of any of the variables measured in individual level modeling rather than a historical model. Such analysis may include, for example, splits based on message types or consumer segments.

In some embodiments, a model system covers geographic areas broken down into tiers or DMA clusters. Multiple tiers may be used for each brand. Impacts may vary across a tier or cluster. The model may produce media response curves that can be used in optimization.

The time period covered by a modeling approach may depend on such factors as availability of quality data across the key metrics, marketing sales levers, and external factors. In one embodiment, longitudinal data is used from 5 or more years.

In cases in which a full set of data is not available for the chosen period, historical data patterns may be estimated from less granular data or other available records such as media plans. For example, detailed digital impression data may only be available for the latter part of chosen data period, while spend data may be available for the entire period. The strength of the relationship between impression data and spend may be assessed. From the assessment, estimated impression data for the missing period may be produced, for example, using conversions observed in the data.

In some embodiments, a model system incorporates historical models and individual-level models. Assessments made using the combination of historical models and individual-level models may include capturing the long term impact of marketing and more granular assessment relating to intermediate outcomes, consumer segments, message, or intra-media performance.

In various embodiments, a system includes output from models including:

Sales models. Each sales model may cover DMAs in tiers (or other market groups). Media spend may be included in each model.

Specific intermediary measure models. Models may be developed to assess factors including familiarity, product consideration and website.

Brand-level models.

Individual-level models. The individual-level models may be linked to associated sales and intermediate models.

In one embodiment, an individual level model is created for each product (for example, each car model). Responsiveness by sub-channel and consumer segment may be identified by model type. In some embodiments, an overall individual-level model is initially developed. Other individual-level models (for example, for various specific sub-channels or consumer segments) may be scaled in future time periods, for example, as sufficient data becomes available.

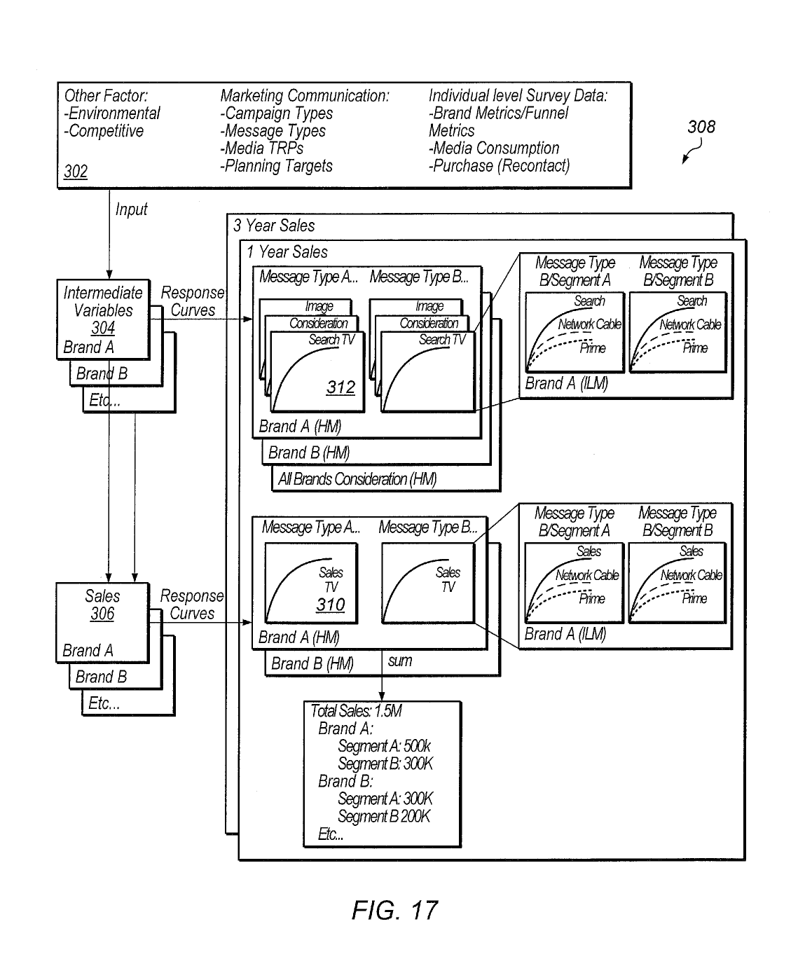

FIG. 17 illustrates one embodiment of using models for generating marketing effectiveness assessments for multiple brands and for multiple consumer segments. System 300 encompasses two or more models for assessing media effectiveness. System 300 includes inputs 302, intermediate variables 304, sales 306, and outputs 308. Outputs 308 include response curves 310 and response curves 312. Response curves 312 may be generated from models that include intermediate variables 304. Response curves 310 may be generated from models that include sales 306. A different response curve may be generated for each brand being evaluated, and also for different message types and segments.

In various embodiments, analysis based on individual level modeling and historical modeling is used in such areas as budget planning, targeting, messaging, media, and evaluation. Some questions that may be addressed using an integrated modeling system include:
How much should be spent on different initiatives (e.g., launches, sales events) to achieve short-term and long-term goals?
Which targets should be focused on? Who can be impacted most effectively and efficiently?
Which consumer perceptions are most valuable to shift? Which messages will create the most value in terms of driving sales—both short-term and long-term?
What is the optimal media mix for a given initiative? How much should be spent overall, and where should it be spent?
How did the organization perform in past initiatives? Which messages and media had the greatest impact?
Short term vs. long term impact on sales, including intermediate dependent variables, where marketing may move people into different beliefs and stages of consideration, and contribute to subsequent downstream sales.
Interactions within, between, and among media, campaigns, consumer segments, and other external factors.

### Example of Integrated Model

In one example, to assess the value of targeting the Age Group 18-30 (Generation Y), response curves from historical modeling are used to represent the aggregate (for example all car types & these specific cars) sales results as the response. Results at different spend levels may be quantified or compared to other targets.

Response curves to advertising from the historical model (along with interactions/dimensions message, campaign type, etc.) may be adjusted by the responsiveness of a consumer segment as measured in an individual-level model. As one example, if a consumer segment was more responsive to Launch Campaign types than the total market, the consumer segment's response curve may be increased from the market average for Launch Campaign types. If the consumer segment was less responsive to Sales Event advertising than the total market, then the consumer segment's response curve may be decreased from the market average for Sales Event advertising campaign type.

All sales results may be reported broken by specific consumer segments identified in advance for each product (for example, each vehicle). Using the above analysis, the value of targeting the 18-30 age may be assessed. In one example, value is assessed against four possible outcomes:
A. If impact of targeted media is very high and segment response is very high, then potentially very valuable (depends on relative ROI compared to other groups).
B. If media impact is very high and segment response is very low, then some other segment is responding highly to media targeted at Gen Y.
C. If media impact is very low but segment response is very high, then segment size may be too small to contribute meaningfully to overall sales, and therefore perhaps not valuable.
D. If both media impact and segment response are low, then potentially not valuable at all (unless ROI is extremely high, but unlikely to be the case).

In one embodiment, econometric modeling factors are combined with the influence of advertising to forecast sales impact. Longitudinal measures of one or more individual consumer attitudes, one or more consumer behaviors, or both consumer attitudes and consumer behaviors, may be calibrated based on econometric data. The econometric data may be used to calibrate measurements for different points in time. For example, one calibration may be performed for week 1, another calibration for week 2 of a campaign, etc. In some embodiments, the same econometric modeling data is used for each calibration. Changes in the economic factor, such as disposable income, may be accounted for in a design of experiments calculation of advertising impact. For example, it might be found that TV advertising has a larger influence during times when disposable income is higher compared to when it is lower.

In various embodiments, methods of assessing advertising effectiveness using historical models and/or individual-level modeling are integrated with, or used in conjunction with, multi-media or cross media advertising assessments, true experimental design, and/or quasi experimental design. Some examples of methods and systems that may be integrated with, or used in conjunction with, methods and systems described herein are included in U.S. Pat. No. 7,949,561, issued May 24, 2011 to Briggs, which is incorporated by reference in its entirety as if fully set forth herein.

### System for Assessing Marketing Over a Network

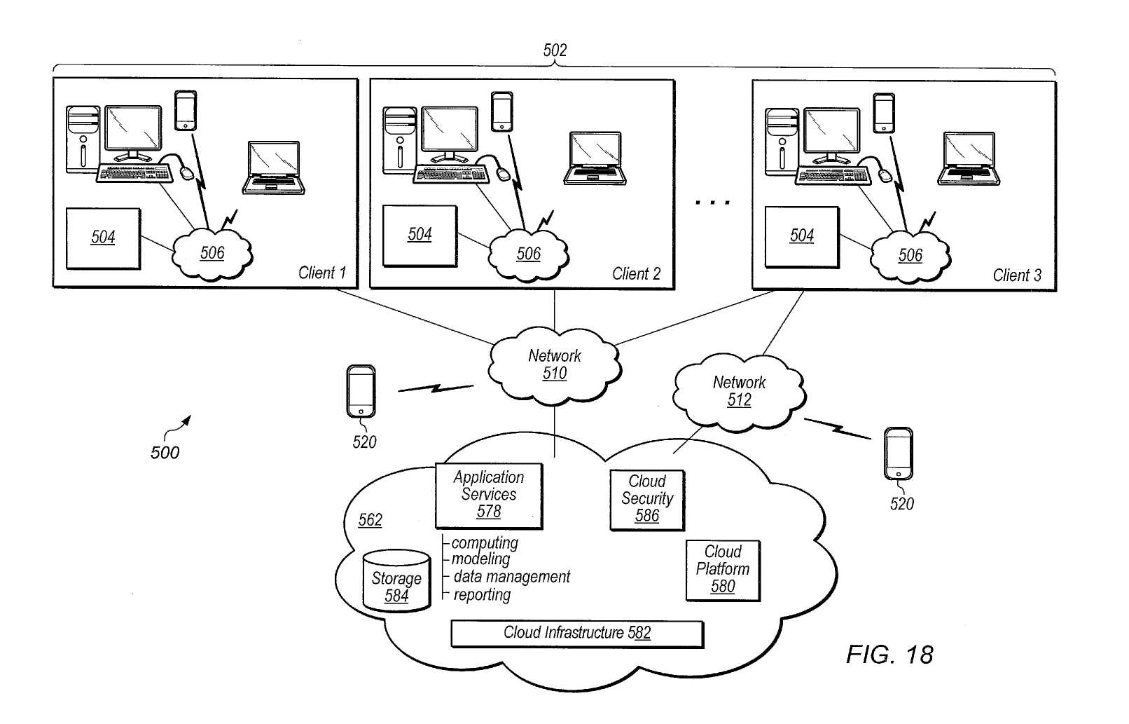

In some embodiments, clients may access data and perform marketing assessments over a computer network. FIG. 18 illustrates one embodiment of a system with which assessments of advertising and marketing effectiveness may be performed over a network. System 500 includes clients 502, including client 1 through client n. Each of clients 502 may include a client computing system 504. Client computing systems 504 may include, for example, a network of computing devices distributed at the site and connected to one another by way of network 506. Each of client computing systems 504 may be connected to cloud computing system 562 by way of network 510. In certain embodiments, client computing systems 504 may be connected to one another by way of network 510.

In various embodiments, some of clients 502 may be connected over a different network than other sites. For example, as shown in FIG. 18, client n may be connected to cloud computing system 562 over network 512. In some embodiments, one or more clients are connected over a private network. For example, in the embodiment shown in FIG. 18, network 510 may be a public network and network 512 may be a private network.

In various embodiments, a user may communicate over systems in system 500 from locations external to clients 502 and cloud computing system 562. For example, users not located at one of clients 502 may communicate with users at clients 502 by way of portable electronic devices 520. Portable electronic devices 520 may be located anywhere.

Although for illustrative purposes only three clients are shown in FIG. 18, a system may include any number of clients and any number of client computer systems. In some embodiments, one client has two or more client computer systems.

In some embodiments, a system for assessing marketing and advertising effectiveness includes a user dashboard. The user dashboard may provide a central view of information and analytical tools accessible from the system. The user dashboard may act as a landing screen for users accessing the system. In some embodiments, each user may be authenticated before access is to the system is provided.

Computer systems may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods.

A computer system may allow access to participants by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

Further modifications and alternative embodiments of various aspects of the invention may be apparent to those skilled in the art in view of this description.

Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A method, comprising:
obtaining, on a computer system, individual-level data corresponding to each of one or more individuals who has been exposed to one or more advertisements for a product or service;
creating, on the computer system, an individual-level model based on one or more factors relating to acquisition of the product or service, wherein the model describes at least one dependent variable at least partially as a function of one or more independent variables at a particular period in time or one or more intermediate variables at a particular period in time; and
assessing a response to at least one of the advertisements based on the individual-level model.

2. The method of claim 1, wherein at least a portion of the individual-level data is data from a survey of at least one individual.

3. The method of claim 1, further comprising:
determining, on the computer system, a representative sample from the individual-level data for at least one of the individuals,
wherein the an individual-level model based on one or more factors relating to acquisition of the product or service.

4. The method of claim 1, wherein at least a portion of the individual data is collected from one or more individual consumers who was exposed to at least one of the advertisements.

5. The method of claim 1, wherein at least one of the variables is an intermediate variable, wherein the intermediate variable relates to a condition or event that exists between the time of exposure of a consumer to one or more of the advertisements and a time of purchase of the product or service.

6. The method of claim 5, wherein a value for at least one of the intermediate variables is determined based on a measure of an attitude of an individual consumer before a purchase of the product or service by the individual.

7. The method of claim 5, wherein a value for at least one of the intermediate variables is determined based on a behavior of an individual consumer before a purchase of the product or service by the individual.

8. The method of claim 5, wherein a value for at least one of the intermediate variables is determined based on brand awareness of one or more individual consumers before a purchase of the product or service.

9. The method of claim 5, wherein a value for at least one of the intermediate variables is determined based on product consideration of one or more individual consumers before a purchase of the product or service.

10. The method of claim 5, wherein a value for at least one of the intermediate variables is determined based on familiarity of one or more individual consumers before a purchase of the product or service.

11. The method of claim 5, wherein a value for at least one of the intermediate variables is determined based on a volume of online searches relating to the product or service.

12. The method of claim 5, wherein a value for at least one of the intermediate variables is determined based on website traffic at a site relating to the product or service.

13. The method of claim 1, wherein the individual level model describes sales of the product or service as a function of at least one the explanatory variables.

14. The method of claim 1, wherein the model comprises at measure of effectiveness for two or more media channels.

15. The method of claim 1, wherein the model comprises at least two independent or intermediate variables.

16. The method of claim 1, further comprising:
creating one or more historical models based at least in part on aggregate data for one or more advertisements relating to the product or service, wherein the created historical models include at least one measure of effectiveness as a function of time for at least one time period; and
determining a measure of effectiveness based at least in part on at least one of the historical models and based at least in part on the individual-level model.

17. The method of claim 16, further comprising adjusting at least one of the historical models based on the individual-level model.

18. The method of claim 1, further comprising measuring at least one individual or group of individuals at two or more periods in time based on the individual-level model.

19. A system, comprising:
a processor;
a memory coupled to the processor and storing program instructions executable by the processor to implement:
obtaining individual-level data corresponding to each of one or more individuals who has been exposed to one or more advertisements for a product or service;
creating an individual-level model based on one or more factors relating to acquisition of the product or service, wherein the model describes at least one dependent variable at least partially as a function of one or more independent variables at a particular period in time or one or more intermediate variables at a particular period in time; and
assessing a response to at least one of the advertisements based on the individual-level model.

20. A tangible, computer readable medium comprising program instructions stored thereon, wherein the program instructions are computer-executable to implement:
obtaining individual-level data corresponding to each of one or more individuals who has been exposed to one or more advertisements for a product or service;
creating an individual-level model based on one or more factors relating to acquisition of the product or service, wherein the model describes at least one dependent variable at least partially as a function of one or more independent variables at a particular period in time or one or more intermediate variables at a particular period in time; and
assessing a response to at least one of the advertisements based on the individual-level model.

21-40. (canceled)
